(19) United States
(12) Patent Application Publication
(10) Pub. No.: US 2026/0214404 A1
(43) Pub. Date: Jul. 23, 2026

(54) RENDERING OF OCCLUDED AUDIO ELEMENTS

(71) Applicant: Telefonaktiebolaget LM Ericsson (publ), Stockholm (SE)

(72) Inventors: Tommy FALK, SPÅNGA (SE); Werner DE BRUIJN, STOCKHOLM (SE)

(21) Appl. No.: 19/134,914

(22) PCT Filed: Dec. 6, 2023
(86) PCT No.: PCT/EP2023/084425

§ 371 Date: Jun. 2, 2025

Related U.S. Application Data
(60) Provisional application No. 63/430,399, filed on Dec. 6, 2022.

(51) Int. Cl. H04S 7/00

(52) U.S. Cl. CPC H04S 7/304; H04S 2400/11

(57) ABSTRACT

A method for rendering an audio element that is at least partially occluded. The method includes obtaining a matrix of occlusion filters, Fo. The method also includes obtaining at least a first mapping matrix, M1. The method also includes using Fo and M1 to generate a matrix of mapped filters, Fs, wherein Fs includes at least a first mapped filter, Fm1, corresponding to a first virtual loudspeaker. The method also includes using Fm1 to modify a first virtual loudspeaker signal for the first virtual loudspeaker, thereby producing a first modified virtual loudspeaker signal. The method also includes using the first modified virtual loudspeaker signal to render the audio element (e.g., generate an output signal using the first modified virtual loudspeaker signal).

### TECHNICAL FIELD

Disclosed are embodiments related to rendering of occluded audio elements.

### BACKGROUND

Spatial audio rendering is a process used for presenting audio within an extended reality (XR) scene (e.g., a virtual reality (VR), augmented reality (AR), or mixed reality (MR) scene) in order to give a listener the impression that sound is coming from physical sources within the scene at a certain position and having a certain size and shape (i.e., extent). The presentation can be made through headphone speakers or other speakers. If the presentation is made via headphone speakers, the processing used is called binaural rendering and uses spatial cues of human spatial hearing that make it possible to determine from which direction sounds are coming. The cues involve inter-aural time delay (ITD), inter-aural level difference (ILD), and/or spectral difference.

The most common form of spatial audio rendering is based on the concept of point-sources, where each sound source is defined to emanate sound from one specific point. Because each sound source is defined to emanate sound from one specific point, the sound source doesn't have any size or shape. In order to render a sound source having an extent (size and shape), different methods have been developed.

One such known method is to create multiple copies of a mono audio element at positions around the audio element. This arrangement creates the perception of a spatially homogeneous object with a certain size. This concept is used, for example, in the “object spread” and “object divergence” features of the MPEG-H 3D Audio standard (see references [1] and [2]), and in the “object divergence” feature of the EBU Audio Definition Model (ADM) standard (see reference [4]). This idea using a mono audio source has been developed further as described in reference [7], where the area-volumetric geometry of a sound object is projected onto a sphere around the listener and the sound is rendered to the listener using a pair of head-related (HR) filters that is evaluated as the integral of all HR filters covering the geometric projection of the object on the sphere. For a spherical volumetric source this integral has an analytical solution. For an arbitrary area-volumetric source geometry, however, the integral is evaluated by sampling the projected source surface on the sphere using what is called a Monte Carlo ray sampling.

Another rendering method renders a spatially diffuse component in addition to a mono audio signal, which creates the perception of a somewhat diffuse object that, in contrast to the original mono audio element, has no distinct pin-point location. This concept is used, for example, in the “object diffuseness” feature of the MPEG-H 3D Audio standard (see reference [3]) and the “object diffuseness” feature of the EBU ADM (see reference [5]).

Combinations of the above two methods are also known. For example, the “object extent” feature of the EBU ADM combines the creation of multiple copies of a mono audio element with the addition of diffuse components (see reference [6]).

In many cases the actual shape of an audio element can be described well enough with a basic shape (e.g., a sphere or a box). But sometimes the actual shape is more complicated and needs to be described in a more detailed form (e.g., a mesh structure or a parametric description format).

In the case of heterogeneous audio elements, as are described in reference [8], the audio element comprises at least two audio channels (i.e., audio signals) to describe a spatial variation over its extent.

In some XR scenes there may be an object that blocks at least part of an audio element in the XR scene. In such a scenario the audio element is said to be at least partially occluded. That is, occlusion happens when, from the viewpoint of a listener at a given listening position, an audio element is completely or partly hidden behind some object such that no or less direct sound from the occluded part of the audio element reaches the listener. Depending on the material of the occluding object, the occlusion effect might be either complete occlusion (e.g. when the occluding object is a thick wall), or soft occlusion where some of the audio energy from the audio element passes through the occluding object (e.g., when the occluding object is made of thin fabric such as a curtain). Soft occlusion can often be well described by a filter with a certain frequency response that corresponds to the acoustic characteristics of the material of the occluding object.

Occlusion is typically detected using some form of raytracing algorithm where a ray is sent from the listening position towards the position of the audio object and where any occlusions on the way are identified. This works well for point sources where there is one defined position for the audio object. However, for an audio object that has an extent this simple process is not directly applicable. In this case the whole extent needs to be checked for occlusion. Also, in the case that the audio object is a heterogeneous audio element where there is spatial information that should be rendered so that it appears to come from the extent of the audio object, special care is needed in order for this spatial information to be correctly taken into account in the handling of the occlusion.

### SUMMARY

Certain challenges presently exist. For example, available occlusion rendering techniques show how occlusion filters can be calculated for different subareas of an extent of a volumetric audio object and that these occlusion filters can then be mapped to a set of virtual loudspeakers and thereby provide a plausible occlusion of the audio object, but, in many cases the straight-forward one-to-one mapping of occlusion filters of subareas to a set of virtual loudspeakers may not be optimal, and, in some cases, the setup of virtual loudspeakers is changing over time which requires that the mapping be adapted accordingly. Further, the mapping needs to be done in a way so that the distribution of sound energy over the extent is not changing unnaturally as the speaker setup is adapted and/or the occlusion characteristic changes. The spatial characteristic of the occlusion effect also needs to be rendered as accurately as possible regardless of the speaker setup. These requirements are typically not met with a straight-forward one-to-one mapping.

Accordingly, in one aspect there is provided a method for rendering an audio element that is at least partially occluded. The method includes obtaining a matrix of occlusion filters, Fo. The method also includes obtaining at least a first mapping matrix, M1. The method also includes using Fo and M1 to generate a matrix of mapped filters, Fs, wherein Fs includes at least a first mapped filter, Fm1, corresponding to a first virtual loudspeaker. The method also includes using Fm1 to modify a first virtual loudspeaker signal for the first virtual loudspeaker, thereby producing a first modified virtual loudspeaker signal. The method also includes using the first modified virtual loudspeaker signal to render the audio element (e.g., generate an output signal using the first modified virtual loudspeaker signal).

In another aspect there is provided an audio rendering apparatus, wherein the audio rendering apparatus is configured to perform a method for rendering an at least partially occluded audio element. The method includes obtaining a matrix of occlusion filters, Fo. The method also includes obtaining at least a first mapping matrix, M1. The method also includes using Fo and M1 to generate a matrix of mapped filters, Fs, wherein Fs includes at least a first mapped filter, Fm1, corresponding to a first virtual loudspeaker. The method also includes using Fm1 to modify a first virtual loudspeaker signal for the first virtual loudspeaker, thereby producing a first modified virtual loudspeaker signal. The method also includes using the first modified virtual loudspeaker signal to render the audio element (e.g., generate an output signal using the first modified virtual loudspeaker signal).

In another aspect there is provided a computer program comprising instructions which when executed by processing circuitry of an audio renderer causes the audio renderer to perform either of the above described methods. In one embodiment, there is provided a carrier containing the computer program wherein the carrier is one of an electronic signal, an optical signal, a radio signal, and a computer readable storage medium.

An advantage of the embodiments disclosed herein is that they make it possible to render a dynamic occlusion effect for audio sources with an extent based on occlusion filters representing different subareas of an extent. The embodiments support an adaptive rendering setup where the number of virtual speakers and their positions may change continuously.

### BRIEF DESCRIPTION OF THE DRAWINGS

The accompanying drawings, which are incorporated herein and form part of the specification, illustrate various embodiments.

FIG. 1 shows an example rectangular extent corresponding to an audio source.

FIG. 2. is a flowchart illustrating a process according to an embodiment.

FIGS. 3A and 3B show a system according to some embodiments.

FIG. 4 illustrates a system according to some embodiments.

FIG. 5 illustrates a signal modifier according to an embodiment.

FIG. 6 is a block diagram of an apparatus according to some embodiments.

FIG. 7 shows two point sources (S1 and S2) and an occluding object (O).

FIG. 8 shows an audio element having an extent being partially occluded by an occluding object.

FIG. 9 illustrates a process for determining an edge of a modified extent.

FIG. 10 illustrates a modified extent.

FIG. 11 illustrates an audio element for which no edge of the element's extent is completely occluded.

FIG. 12A illustrates the effect of a moving occluding object when detection of occlusion is be made with a uniform grid of ray casts.

FIG. 12B illustrates the effect of a moving occluding object when detection of occlusion is be made with a uniform grid of ray casts.

FIG. 13A illustrates the effect of a moving occluding object when detection of occlusion is be made with a skewed grid of ray casts.

FIG. 13B illustrates the effect of a moving occluding object when detection of occlusion is be made with a skewed grid of ray casts.

FIG. 14 is a flowchart illustrating a process according to an embodiment.

### DETAILED DESCRIPTION

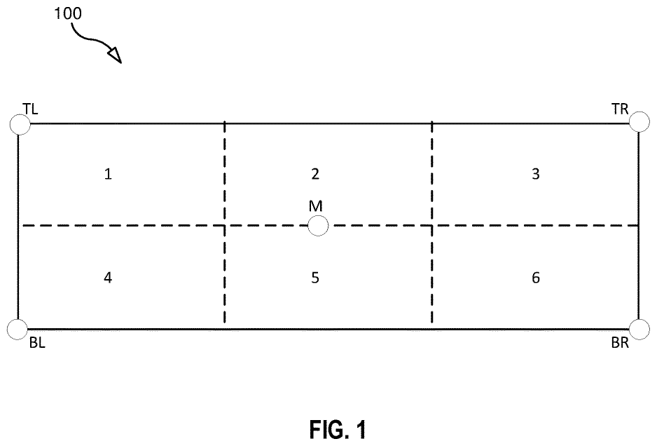

FIG. 1 is an example of where an audio element 100 (or, more precisely, the extent of the audio element as seen from the listener position) is logically divided into six parts (a.k.a., six subareas), where parts 1 & 4 represents the left area of the audio element, parts 3 & 6 represents the right area, and parts 2 & 5 represents the center. Also, parts 1, 2 & 3 together represent the upper area of the audio element and parts 4, 5 & 6 represent the lower area of the audio element. As further illustrated, five virtual loudspeakers (TL, TR, BL, BR, and M) are used to render the audio element (a.k.a., audio source).

A separate occlusion filter is obtained (e.g., derived or calculated) for each subarea. A filter is a set of one or more gain values (a.k.a., “gain factors”) where each gain value is associated with a different set of one or more frequency ranges. An example filter is: F={g1, g2, g3}, where g1 is a gain value for a first frequency range, g2 is a gain value for a second frequency range, and g3 is a gain value for a third frequency range. An occlusion filter is a filter wherein the gain values are determined based on a detected amount of occlusion. For example, an occlusion filter for a first subarea of an audio element that is completely occluded might be: F1o={0, 0, 0}, whereas an occlusion filter for a second subarea of an audio element that is not at all occluded might be: F2o={1, 1, 1}, and an occlusion filter for a third subarea of an audio element that is partially occluded or soft occluded might be: F3o={0.7, 0.5, 0.3}. A method for deriving an occlusion filter is described in U.S. provisional patent application No. 63/388,685, filed on Jul. 13, 2022, relevant portions of which are included herein under the heading “Additional Material.”

The most straight forward mapping of occlusion filters for subareas of an extent to virtual loudspeakers would be if each subarea is represented with one virtual loudspeaker positioned in the center of the subarea. In this case, the occlusion filter for each subarea would be directly applied to the corresponding virtual loudspeaker signal. However, that would mean that each subarea is represented as a point-source. In this case the extent would be reduced to a point-source if only one subarea is active. A one-to-one mapping of subareas to loudspeaker is also less flexible and problematic when the rendering setup is adaptive.

For example, in FIG. 1, if all subareas except subarea 1 were completely occluded, only loudspeaker TL would be used for the rendering. This would result in that subarea 1 would be represented as a point-source located in its top left corner.

A mapping where each subarea is represented by several virtual loudspeakers can produce a more accurate spatial impression of the size of the subarea and provide a smoother change when the occlusion changes dynamically.

To support an adaptive rendering system that uses several virtual speaker configurations (a.k.a., “speaker setups”), one mapping matrix per speaker setup is defined. One or more control parameters are then used to control the transitions between the different mapping matrices. Typically, these control parameters are provided by a speaker setup module that controls the adaptation of the speaker setup so that the transition of the mapping matrices can be done synchronously to the speaker setup adaptation.

With reference to FIG. 1, which shows an example where the extent is divided into six subareas, 1-6, and five virtual loudspeakers are used to render the audio source, the filters for the signals going to each virtual loudspeaker can be calculated using a mapping matrix as:

$$[ \begin{matrix}{f}_{TL} \\ {f}_{TR} \\ {f}_{BL} \\ {f}_{BR} \\ {f}_{M}\end{matrix} ] = [ \begin{matrix}{m}_{1 TL} & {m}_{2 TL} & {m}_{3 TL} & {m}_{4 TL} & {m}_{5 TL} & {m}_{6 TL} \\ {m}_{1 TR} & {m}_{2 TR} & {m}_{3 TR} & {m}_{4 TR} & {m}_{5 TR} & {m}_{6 TR} \\ {m}_{1 BL} & {m}_{2 BL} & {m}_{3 BL} & {m}_{4 BL} & {m}_{5 BL} & {m}_{6 BL} \\ {m}_{1 BR} & {m}_{2 BR} & {m}_{3 BR} & {m}_{4 BR} & {m}_{5 BR} & {m}_{6 BR} \\ {m}_{1 BM} & {m}_{2 BM} & {m}_{3 BM} & {m}_{4 BM} & {m}_{5 BM} & {m}_{6 BM}\end{matrix} ] [ \begin{matrix}f 1 \\ f 2 \\ f 3 \\ f 4 \\ f 5 \\ f 6\end{matrix} ]$$

Where f1-f6 denotes the occlusion filters for the subareas 1-6 and f_{TL}, f_{TR}, f_{BL}, f_{BR}, and f_{M} are the “mapped” filters that are applied to the signals going to the virtual loudspeakers TL, TR, BL, BR and M, respectively. The entries of the mapping matrix are scaling factors that specify how much of the occlusion filters f1-f6 should be applied to the different virtual loudspeakers. Denoting the matrix of occlusion filters f1-f6 as F_{O}, the matrix of mapped filters as F_{S} and the mapping matrix as M, the calculation can be described in more compact form as: F_{S}=MF_{O}.

To assure that the occlusion rendering does not affect the overall gain of the audio source in an undesirable way, the mapping matrix should be specified so that if the occlusion filters f1-f6 have no suppression in any frequency range, i.e., the filters are all unity filter vectors, the mapped filters should also be unity vectors. This also assures that the spatial energy distribution over the extent is not affected by the occlusion rendering when there is no occlusion. This requirement can be met by specifying a mapping matrix where the sum of each row equals 1.

If the subareas are equally sized, and/or are expected to have equal effect on the overall occlusion, also the sum of each column should equal 1.

In the example of FIG. 1, the occlusion filter of subarea 1 should mainly be applied to virtual loudspeaker TL but probably also M and BL to spread the effect over an area that corresponds to the subarea. As an example, this may be achieved by a mapping matrix having a first column, corresponding to subarea 1, with values specified as follows:

$$[ \begin{matrix}{f}_{TL} \\ {f}_{TR} \\ {f}_{BL} \\ {f}_{BR} \\ {f}_{M}\end{matrix} ] = [ \begin{matrix}0.5 & {m}_{2 TL} & {m}_{3 TL} & {m}_{4 TL} & {m}_{5 TL} & {m}_{6 TL} \\ 0. & {m}_{2 TR} & {m}_{3 TR} & {m}_{4 TR} & {m}_{5 TR} & {m}_{6 TR} \\ 0.25 & {m}_{2 BL} & {m}_{3 BL} & {m}_{4 BL} & {m}_{5 BL} & {m}_{6 BL} \\ 0. & {m}_{2 BR} & {m}_{3 BR} & {m}_{4 BR} & {m}_{5 BR} & {m}_{6 BR} \\ 0.25 & {m}_{2 BM} & {m}_{3 BM} & {m}_{4 BM} & {m}_{5 BM} & {m}_{6 BM}\end{matrix} ] [ \begin{matrix}f 1 \\ f 2 \\ f 3 \\ f 4 \\ f 5 \\ f 6\end{matrix} ]$$

Here the scaling factors in the first column specify that the occlusion filter f1 should be multiplied by 0.5 and then applied to the signal going to virtual loudspeaker TL. The occlusion filter f1 is also multiplied by 0.25 and applied to the signals going to virtual loudspeakers BL and M. This has the effect that if subarea 1 is completely occluded, also loudspeakers BL and M are affected but to a lesser degree than TL. If all subareas except subarea 1 are completely occluded, subarea 1 will be rendered through speakers TL, BL, and M.

Similar reasonings are used to derive the scaling factors for the occlusion filters of the other sub-areas, i.e., the other columns of the mapping matrix M, finally resulting in the complete mapping matrix M for the given virtual loudspeaker set up.

The matrix M may be optimized manually for specific loudspeaker setups that are used or may be derived automatically to enable completely adaptive scenarios.

Although the description above used a specific example with 6 sub-areas and 5 virtual loudspeakers, the concept is easily generalized to systems with arbitrary numbers of sub-areas and virtual loudspeakers, as expressed by the formulation as a general matrix multiplication provided above.

In one embodiment, the entries of the mapping matrix are not scalar, but frequency dependent scaling factors. In this case, the mapping can be done differently for different frequencies, e.g., so that the occlusion for lower frequencies has an effect that is more spread out over the extent compared to the occlusion effect for higher frequencies. The calculation involved in the mapping would work the same as described above, but would have to be done independently for each frequency band.

### Power/Gain Normalization

The mapping of the occlusion filters to the virtual loudspeakers should be such that the total amount of energy radiated by the partially occluded audio element is consistent, both in terms of the dynamic behavior (consistent change of total radiated energy when the amount and/or spatial distribution of the occlusion is changing), and in terms of being consistent with the fraction of the total extent that is occluded. For example, if 40% of the size (area) of the extent is occluded, then the total radiated power of the virtual loudspeakers combined should be 40% lower than if the extent is totally non-occluded (assuming a diffuse distribution of energy over the extent).

This requirement can be achieved by normalizing the mapping matrix M in a suitable way or, equivalently, adding a suitable normalization to the mapping equation or the calculated mapped filters.

Specifically, the total power P_{non-occluded} emitted by the virtual loudspeakers for the non-occluded extent may (for a single frequency band) be determined by evaluating the mapping equation with a unity filter vector F₀:

$$[ \begin{matrix}{B}_{1} \\ ⋮ \\ {B}_{N}\end{matrix} ] = {[ \begin{matrix}{f}_{1} \\ ⋮ \\ {f}_{N}\end{matrix} ]}_{non - occluded} = [ \begin{matrix}{m}_{11} & … & {m}_{1 M} \\ ⋮ & ⋱ & ⋮ \\ {m}_{N 1} & … & {m}_{NM}\end{matrix} ] [ \begin{matrix}1 \\ ⋮ \\ 1\end{matrix} ] ,$$

with N the number of virtual loudspeakers and M the number of occlusion filters (in the example described above M=6 and N=5, and the indices i=1 . . . 5 correspond to the TL, TR, BL, BR and M virtual loudspeakers, respectively), and where:

$${B}_{i} = {\sum }_{j = 1}^{M} {m}_{ij} , i = 1 ... N ,$$

is the sum of the mapping coefficients for the i-th virtual loudspeaker. The total emitted power P_{non-occluded} of the non-occluded extent now follows from:

$${P}_{non - occluded} = {{‖ {F}_{S} ‖}_{non - occluded}^{2}}^{2} = {\sum }_{i = 1}^{N} {B}_{i}^{2} .$$

If we now similarly determine the total power emitted by the virtual loudspeakers for the occluded extent, i.e: P_{occluded}=∥F_{S}∥², and define A to be the (current) total amount of occlusion (including the effects of both hard and soft occlusion of the extent), expressed as the fraction of the total extent area that is occluded (or, equivalently, the fraction of the total radiated power that is “lost” due to the occlusion), then we have the following requirement:

$${P}_{occluded} = ( 1 - A ) * {P}_{non - occluded} ,$$

from which it follows that we require that:

$${P}_{occluded} = ( 1 - A ) * {\sum }_{i = 1}^{N} {B}_{i}^{2} .$$

This requirement can be met by scaling the virtual loudspeaker filters by a factor C that takes care of this normalization, i.e:

$${P}_{occluded} = {C}^{2} * {{‖ {F}_{S} ‖}_{non - normalized}^{2}}^{2} ,$$

in which ∥F_{S}∥_{non-normalized} is the 2-norm of the vector of mapped filters F_{S} without the normalization, from which follows:

$${C}^{2} = ( 1 - A ) * \frac{{\sum }_{i = 1}^{N} {B}_{i}^{2}}{{{‖ {F}_{S} ‖}_{non - normalized}^{2}}^{2}} = ( 1 - A ) * \frac{{\sum }_{i = 1}^{N} {B}_{i}^{2}}{{‖ {MF}_{O} ‖}^{2}} .$$

The normalized mapped filters are now calculated as:

$${F}_{S , normalized} = {CMF}_{O} = \sqrt{( 1 - A )} * \sqrt{{\sum }_{i = 1}^{N} {B}_{i}^{2}} * \frac{{MF}_{O}}{‖ {MF}_{O} ‖} .$$

The first and third term on the right-hand side of this equation are dynamic functions of the occlusion state of the audio element, whereas the second term is fully determined by the mapping matrix M.

The power/gain normalization equations derived above may be suitable for many types of audio elements having an extent, and in particular for audio elements for which the virtual loudspeakers signals can be considered reasonably uncorrelated with respect to each other. For audio elements with fully coherent virtual loudspeakers a similar normalization scaling can be derived, where the scaling factor C² may be proportional to the square of the sum of all elements of the mapping matrix M.

### Handling Adaptive Rendering Setups

If the speaker setup is adaptive, so that the number of speakers and their positions may change, one mapping matrix may be specified for each of a number of rendering setups of virtual loudspeakers. A scalar control parameter can then be used to interpolate between the different mapping matrices:

$${F}_{S} = ( a {M}_{1} + ( 1.0 - a ) {M}_{2} ) {F}_{O}$$

where a is a control parameter and M₁ and M₂ are two mapping matrices corresponding to two different rendering setups. The equation can be generalized for an arbitrary number of mapping matrices:

$${F}_{S} = ( {\sum }_{i = 1}^{N} {a}_{i} {M}_{i} ) {F}_{O}$$

where the control parameters ai should always satisfy

$${\sum }_{i = 1}^{N} {a}_{i} = 1.$$

If a power or gain normalization of the mapped filters, as described in the previous section, is to be carried out, then this may typically be done on the interpolated mapping matrix (e.g., (aM₁+(1.0−a)M₂) or

$$( {\sum }_{i = 1}^{N} {a}_{i} {M}_{i} ) )$$

rather than on the individual mapping matrices, although the latter is also possible.

Some examples of how the adaptation of a rendering setup can be done are given in International Patent Application No. PCT/EP2022/078163, filed Oct. 11, 2022 and titled “Configuring Virtual Loudspeakers,” where some embodiments use a rendering setup that is adapted between three basic virtual speaker setups depending on the angular width and height of the extent of the audio object as seen from the listening position. For sources that have a considerable angular width and height, a five virtual speaker setup is used, where the virtual speakers are placed in each corner and the center. This can be called the plane representation. For a source which is having a small angular height, three speakers are used. In this case the speakers are placed at the left and right edge and the center of the extent. This can be called the line representation. For a source where both the angular width and height are considered small, only one virtual loudspeaker is used placed in the center. This can be called the point representation.

For each of these three different virtual loudspeaker setups, an occlusion filter mapping matrix is defined as described above. In order to adapt between the three different virtual loudspeaker setups, for example in response to changes in the listening distance to the audio object, a two-stage linear interpolation between the individual mapping matrices can be carried out to calculate the occlusion filters for the virtual loudspeakers.

In a first stage, the angular width of the audio object can be evaluated. If the angular width is relatively small, the point source representation with one virtual loudspeaker can be used. If the angular width is considerable, either the line or plane representation can be used, depending on the angular height. Following this reasoning, a scalar weight of the mapping matrix corresponding to the point representation can be calculated as:

$${a}_{POINT} = 1 - horizontal\_trans ( w ) ,$$

where horizontal_trans( ) is a function of the angular width w. The function should go from 0 to one 1 as the angular width goes from 0 to 180°. An example of such a function is:

$$horizontal\_trans ( w ) = \frac{sin ( w ) - sin ( angleStartHoriz )}{sin ( angleEndHoriz ) - sin ( angleStartHoriz )}$$

where angleStartHoriz represents an angle where the transition from point source to either line or plane representation should start, and angleEndHoriz represents an angle where the transition should end (i.e., should be completed).

The scalar weight of the mapping matrix corresponding to the line representation can be calculated as:

$${a}_{LINE} = horizontal\_trans ( w ) ( 1 - vertical\_trans ( h ) ) ,$$

where vertical_trans( ) is a function of the angular height h. As with the horizontal_trans the function should go from 0 to one 1 as the angular height goes from 0 to 180°. An example of such a function is:

$$vertical\_trans ( h ) = \frac{sin ( h ) - sin ( angleStartVert )}{sin ( angleEndVert ) - sin ( angleStartVert )}$$

with definitions of the vertical transition start- and end angles similar to their horizontal counterparts above.

The scalar weight of the mapping matrix corresponding to the plane representation can be calculated as:

$${a}_{PLANE} = horizontal\_trans ( w ) * vertical\_trans ( h ) .$$

With this adaptive interpolation, the scalar weight a_{POINT} will be dominant if the angular width is small. The scalar weight a_{LINE} will be dominant if the angular width is large but the angular height is small. The scalar weight a_{PLANE} will be dominant if both the angular width and height are large.

In this embodiment there is no special virtual loudspeaker setup for the case where the angular width is small, but the angular height is considerable. In order to steer the adaptation towards the use of the point representation in this case, the function vertical_trans(h) can be restricted so that it never exceeds the value of the function horizontal_trans(w):

$$vertical\_trans ( h ) = max ( horizontal\_trans ( w ) , \frac{sin ( h ) - sin ( angleStartVert )}{sin ( angleEndVert ) - sin ( angleStartVert )} ) .$$

Finally, the occlusion filter of the virtual speakers can be calculated as

$${F}_{S} = ( {a}_{POINT} {M}_{POINT} + {a}_{LINE} {M}_{LINE} + {a}_{PLANE} {M}_{PLANE} ) \times Fo .$$

where a_{POINT}+a_{LINE}+a_{PLANE}=1, and Mₚₒᵢₙₜ, Mₗᵢₙₑ and Mₚₗₐₙₑ are the mapping matrices corresponding to the point, line and plane virtual loudspeaker configurations, respectively.

In one embodiment, angleStartHoriz=π/32, angleEndHoriz=π/12, angleStartVert=π/32, and angleEndVert=π/12.

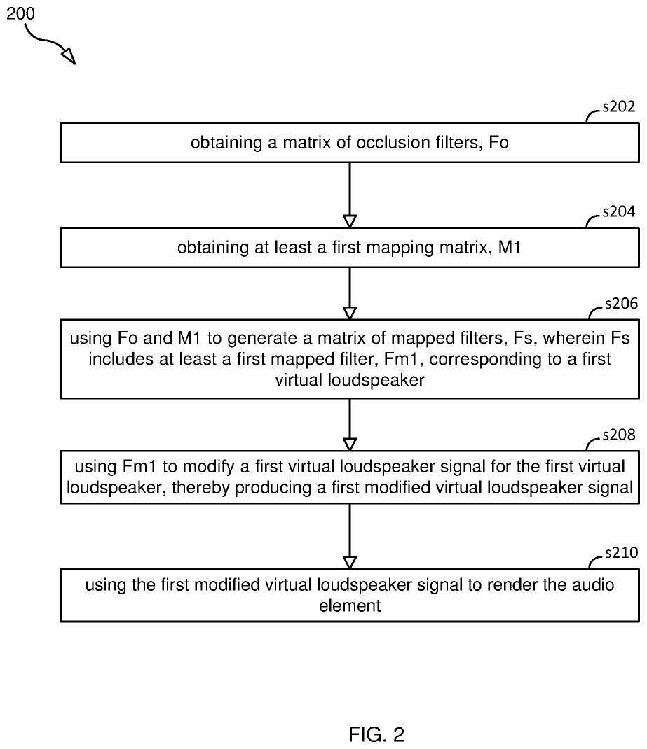

FIG. 2 is a flowchart illustrating a process 200, according to an embodiment, for rendering an at least partially occluded audio element. Process 200 may begin in step s202.

Step s202 comprises obtaining a matrix of occlusion filters, Fo.

Step s204 comprises obtaining at least a first mapping matrix, M1.

Step s206 comprises using Fo and M1 to generate a matrix of mapped filters, Fs, wherein Fs includes at least a first mapped filter, Fm1, corresponding to a first virtual loudspeaker.

Step s208 comprises using Fm1 to modify a first virtual loudspeaker signal (e.g., VS1, VS2, or . . . ) for the first virtual loudspeaker, thereby producing a first modified virtual loudspeaker signal.

Step s210 comprise using the first modified virtual loudspeaker signal to render the audio element (e.g., generate an output signal using the first modified virtual loudspeaker signal).

### Additional Material

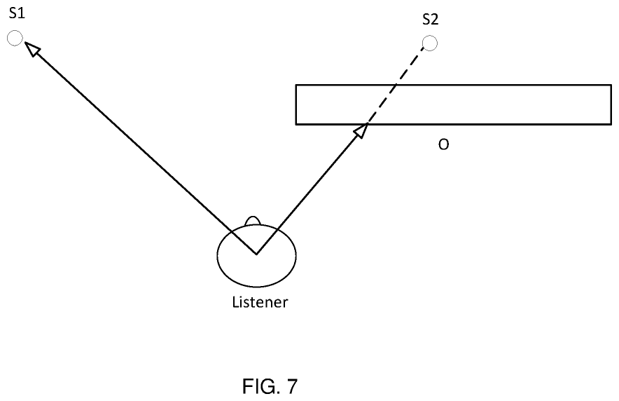

The occurrence of occlusion may be detected using raytracing methods where the direct sound path (or “path” for short) between the listener position and the position of the audio element is searched for any objects occluding the audio element. FIG. 7 shows an example of two point sources (S1 and S2), where one (i.e., S2) is occluded by an object (O) (which is referred to as the “occluding object”) from the listener's perspective and the other (i.e., S1) is not occluded from the listener's perspective. In this case the occluded audio element S2 should be muted in a way that corresponds to the acoustic properties of the material of the occluding object. If the occluding object is a thick wall, the rendering of the direct sounds from the occluded audio element should be more or less completely muted.

For a given frequency range, any given portion of an audio element may be completely occluded, partially occluded, or not occluded. The frequency range may be the entire frequency range that can be perceived by humans or a subset of that frequency range. In one embodiment, a portion of an audio element is completely occluded in a given frequency range when an occlusion gain factor (or “gain” for short) associated with the portion of the audio element satisfies a predefined condition. For example, a portion of an audio element is completely occluded in a given frequency range when an occlusion gain (which may be frequency dependent or not) associated with the portion of the audio element is less than or equal to a threshold gain value (T), where the value T is a selected value (e.g., T=0 is on possibility). That is, for example, any occluding object or objects that let through less than a certain amount of sound is seen as complete occlusion. In another embodiment there is a frequency dependent decision where the amount of occlusion in different frequency bands is compared to a predefined table of thresholds for these frequency bands. Yet another embodiment uses the current signal power of the audio signal representing the audio source and estimates the actual sound power that is let through to the listener, and then compares the sound power to a hearing threshold. In short, a completely occluded audio element (or portion thereof) may be defined as a sound path where the sound is so suppressed that it is not perceptually relevant. This includes the case where the occlusion is completely blocking, i.e., no sound is let through at all, as well as the case where the occluding object(s) only let through a very small amount of the original sound energy such that it is not contributing enough to have a perceptual impact on the total rendering of the audio source.

A portion of an audio element is completely occluded when, for example, there is a “hard” occluding object on the sound path—i.e., a virtual straight line from the listening position to the portion of the audio element. An example of a hard occluding object is a thick brick wall. On the other hand, the portion of the audio element may be partially occluded when, for example, there is a “soft” occluding object on the sound path. An example of a soft occluding object is thin curtain.

If one or several soft occluding objects are in the sound path, the occlusion effect can be calculated as a filter, which corresponds to the audio transmission characteristics of the material. This filter may be specified as a list of frequency ranges and, for each listed frequency range, a corresponding gain. If more than one soft occluding object is in a path, the filters of the materials of those objects can be multiplied together to form one compound filter corresponding to the audio transmission character of that path.

The raytracing can be initiated by specifying a starting point and an endpoint or it can be initiated by specifying a starting point and a direction of the ray in polar format, which means a horizontal and vertical angle plus, optionally a length. The occlusion detection is repeated either regularly in time or whenever there was an update of the scene, so that a renderer has up-to-date occlusion information.

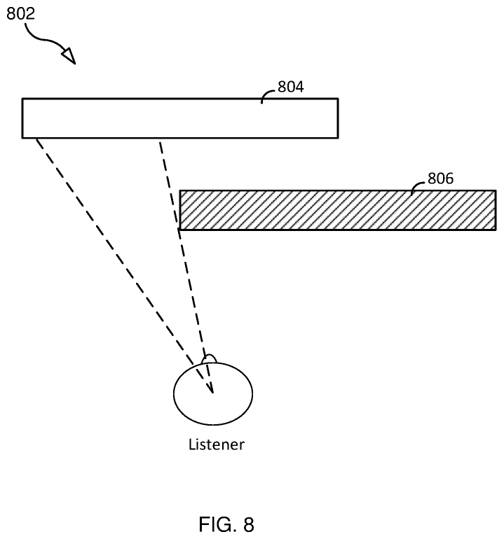

In the case of an audio element 802 with an extent 804, as shown in FIG. 8, the extent of the audio element may be only partly occluded by an occluding object 806. This means that the rendering of the audio element 802 needs to be altered in a way that reflects what part of the extent is occluded and what part is not occluded. The extent 804 may be the actual extent of the audio element 802 as seen from the listener position or a projection of the audio element 802 as seen from the listener position, where the projection may be for example the projection of the extent of the audio element onto a sphere around the listener or a projection of the extent of the audio element onto a plane between the audio element and the listener.

### 1.1. Aspects of Occlusion Detection and Rendering

The process of detecting occlusion of an extent, from the point of view of a listener, will typically involve checking the path between the position of the listener (“listening position”) and each one of a large number of points on the extent for occluding objects. Both the geometry calculations involved in the ray tracing and the calculations of audio transmission filters require some processing, which means that the number these paths (i.e., points on the extent) that are checked should be minimized.

When rendering the effect of occlusion for an audio object with an extent, there are certain aspects that are the perceptually most important. The human auditory system is very good at making out the angle of audio objects in the horizontal plane, often referred to as the azimuth angle, since we can make use of the timing differences between the sound that reaches the right and left ear respectively. Under ideal circumstances humans can discern a difference in horizontal angle of only 1°. For the vertical angle, often referred to as the elevation angle, there are no timing differences that can help the auditory system. Instead, the only cues that our spatial hearing uses to differentiate between different vertical angles is the difference in frequency response that comes from the filtering from our ears, which is different for different vertical angles. Hence the accuracy of the vertical angle is perceptually less important than the horizontal angle.

Even though the vertical position of the top and bottom edge of an extent may not be perceptually critical, the detection of these edges can also affect the overall energy of the audio object. The required resolution due to the change in energy may be higher than due to the perceived change in spatial position.

For an audio object with an extent, the outer edges are the most prominent features, but the energy distribution over the extent also needs to be reflected reasonably well. It is important that changes of positions, energy, or filtering are smooth and does not change in discrete steps, unless there is a sudden movement of the audio source, listener, or some occlude (or any combination thereof).

The most straight-forward way to avoid stepwise changes in the occlusion detection is to use a large number of ray casts, so that smooth changes in occlusion can be tracked with a high resolution. This can make the steps small enough that they are not perceivable. However, a large number of ray casts will add considerably to the complexity of the algorithm.

Another solution is to add temporal smoothing of the occlusion detection and/or occlusion rendering. This will even out sharp steps and make the occlusion effect behave more smoothly. The downside to this is that the response in the occlusion detection/rendering will be slower and not react directly to fast movements. Typically, a tradeoff is made between the resolution and temporal smoothing, so that the detection and rendering is as fast as possible without generating audible steps.

### 1.2 Occlusion Detection in Two Stages

To achieve a high resolution of the most critical aspects of occlusion detection of an audio source with an extent while minimizing the number of ray casts needed, the process can be done in two stages as follows:

First, detecting so called cropping occlusion, which is occlusion that completely occludes at least one edge of the extent. In case of any cropping occlusion (i.e., an entire edge of the extent is completely occluded), a modified extent is calculated where the completely occluded parts are discarded.

Second, using the modified extent where completely occluded parts have been discarded, measure the amount of occlusion by sending out a set of ray casts (e.g., an even distributed set) and calculate an occlusion filter representing different sub-areas of the modified extent.

The first stage is focused on determining whether an edge of the extent is completely occluded, and if so, determining the corresponding edge for the modified extent (i.e., the edge of occlusion). Here iterative search algorithms can be used to find the edges of occlusion. Since the first stage is only detecting complete occlusion, no occlusion filters need to be calculated for each ray cast. This stage is further described in section 1.3.

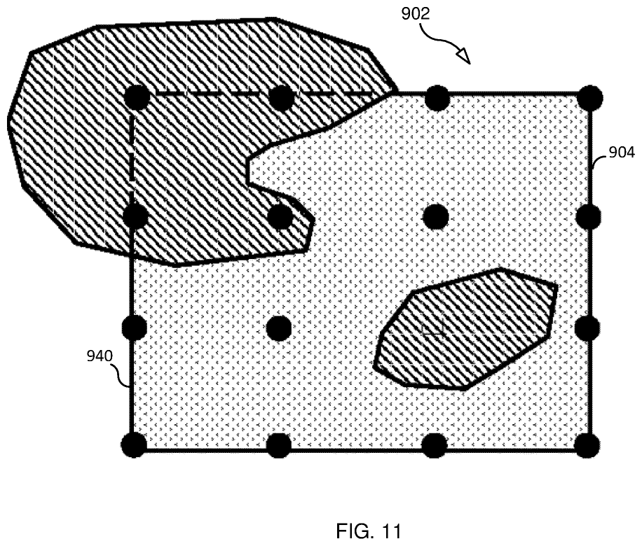

The second stage operates on the modified extent where some completely occluded parts have been discarded. However, it is possible that the “modified” extent is actually not a modified version of the extent but is the same as the extent (this is described further below with respect to FIG. 11). In any event, the focus of this stage is to identify occlusion that happens within the so-called modified extent and calculate occlusion filters that correspond to the occlusion in different sub-areas of the modified extent. This stage is further described in section 1.4.

### 1.3 Optimized Detection of Cropping Occlusion

The detection of cropping occlusion searches for complete occlusion of the edges of the extent of the audio object. Since the auditory system is not well equipped to discern the exact shape of an audio object, this can be simplified into identifying the width and height of the part of the extent that is not completely occluded. This can be done by using an iterative search algorithm, such as a binary search, to find the points on the extent that represents the points with the highest and lowest horizontal angle and highest and lowest vertical angle that are not completely occluded. Using an iterative search algorithm makes it possible to identify the edges of the occlusion with high precision with as few ray casts as possible.

Along with the modified extent, an overall gain factor is calculated that describes the overall gain of the modified extent as compared to the original extent. If a part of the original extent is occluded, that should be reflected in the overall gain of the rendered audio element. The overall gain factor, g_{OV}, can be calculated as

$${g}_{OV} = \sqrt{\frac{{A}_{MOD}}{{A}_{ORG}}}$$

where A_{MOD} is the area of the modified extent and A_{ORG} is the area of the original extent. This is assuming that the audio element can be seen as a diffuse source. If the source is to be seen as a coherent source the gain can be calculated as

$${g}_{OV} = \frac{{A}_{MOD}}{{A}_{ORG}}$$

This overall gain factor should be applied as an overall gain factor when rendering the audio element, either to each sub-area, or to each virtual loudspeaker that is used to render the audio element. Since this stage is only detecting complete occlusion, the gain is valid for the whole frequency range.

The detection of cropping occlusion may start with casting a sparse grid of rays towards the extent to get a first, rough estimate of the edges. The points representing the highest and lowest horizontal and vertical angles, that are not completely occluded, are stored as starting points for iterative searches where the exact edges are found.

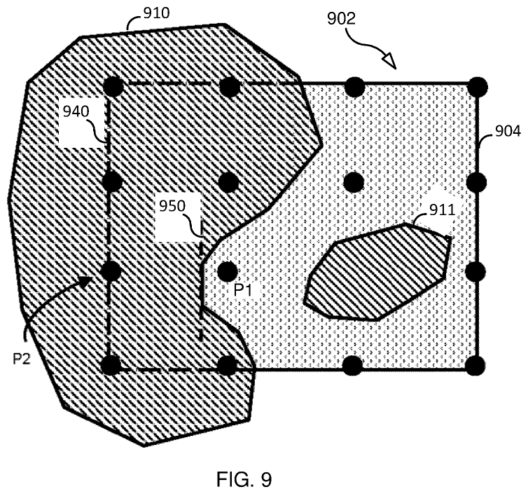

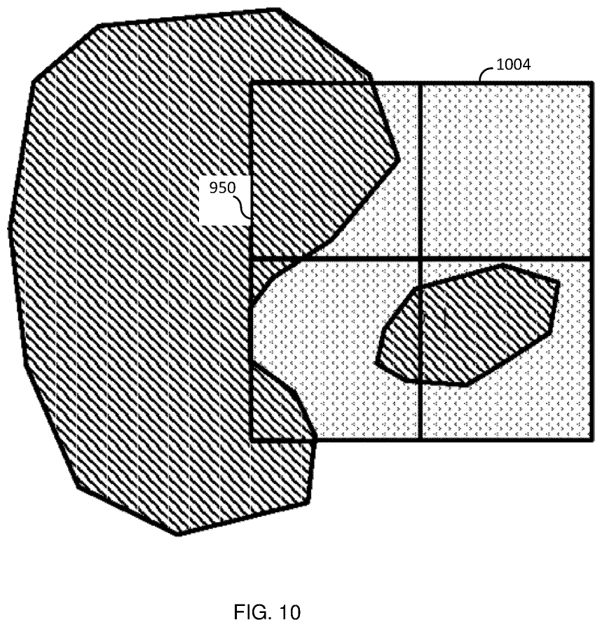

FIG. 9 shows an example where an extent 904 (which in this example is a rectangular extent) of an audio element 902 is occluded by occluders 910 and 911. In one embodiment, the occlusion detection is done in two stages. In the first stage cropping occlusion is detected, and a modified extent 1004 (see FIG. 10) is determined which, in this example, represents a part of the extent 904 (e.g., a rectangular portion of extent 904). That is, in this example, because an entire edge 940 of extent 904 (i.e., the left edge) was completely occluded, modified extent 1004 is smaller than extent 904. More specifically, in this example, modified extent 1004 has a different left edge than extent 904, but the right, top, and bottom edges are the same because none of these edges were completely occluded.

Ray tracing positions are visualized as black dots in FIG. 9. In this example, as shown in FIG. 9, the left edge 950 of the extent 904 is completely occluded by object 910. The ray tracing point P1 is the point that represents the left-most point of the extent that is not occluded. Using a binary search between point P1 and P2, an edge of the occlusion 950 can be found. This edge 950 will then be used as the left edge of the modified extent (a.k.a., “cropped extent”) (see, e.g., FIG. 10), which is used by the next stage. Occluder 911 does not occlude any of the edges and does not have any effect on the modified extent.

In one embodiment, after casting a grid of rays towards an extent, the non-occluded point representing the lowest horizontal angle, P1, is stored as min_azimuth_point. In order to find the exact edge of occlusion a binary search can be used. The binary search uses a lower and an upper bound. In this case, the lower bound can be initialized to min_azimuth_point, or P1. The upper bound is initialized to a point with a lower azimuth angle (to the left in this example) which is known to be either occluded or on the edge of the extent. In this case this can be P2. The search will then start by evaluating the occlusion in the point in-between the lower and higher bound. If this middle point is occluded, the higher bound will be set to this middle point. If this middle point is not occluded the lower bound will be set to this middle point. The process can then be repeated until the distance between the lower and higher bound is below a certain threshold, or it can be repeated a N number of times, where N is a predefined configuration value. The middle point between the higher and lower bounds is then used for describing the azimuth angle of the left edge of the modified extent.

FIG. 11 illustrates an example, where none of the edges of extent 904 are completely occluded. Accordingly, in this example, the determined modified extent will be identical to the extent 904.

The cropping occlusion detection will not detect the exact shape of the occlusion, it will only detect a rectangular part of the extent that is not completely occluded, as shown in FIG. 10. This will however cover many typical cases, where the extent is, for example, partly covered by a wall or when seeing/hearing an audio object through a window. One can think of the cropping occlusion stage as a way to define a frame around the part of the extent that is not completely occluded. Within this frame, there might also be partial or soft occlusion happening. Outside of the cropped extent, there is no need to do further checks for occlusion.

For occlusion where the shape of the occluding objects is more complex, or where there is soft occlusion, the second stage will be used to describe the effect of occlusion within the modified extent.

The density of the sparse grid of rays that is used as the starting point for the search of the edges does not directly influence the accuracy of the edge detection. However, the grid of rays needs to be dense enough that it at least detects one point of the extent that is not occluded, which can then be used as the starting point of the iterative search for the edges of the modified extent. There might be situations where most of the extent is occluded and only a small part is not occluded and if the sparse grid does not identify the non-occluded part of the extent, the iterative search cannot be done properly. Sections 1.5 to 1.7 give some examples of how the sampling grids can be optimized so that also small non-occluded parts are detected without making the sample grids very dense.

1.4 Optimized Detection of Occlusion within the Cropped Extent

The second stage of occlusion detection checks for occlusion within the modified (a.k.a., “cropped”) extent, an example of which is shown in FIG. 10.

This is done by, as shown in FIG. 10, dividing the modified extent 1004 into one or more sub-areas and calculating an occlusion filter for each sub-area of the modified extent. The occlusion filter for a sub-area describes the amount of occlusion in different frequency bands for the sub-area.

Accordingly, in one embodiment, the modified extent (i.e., extent 904 or 1004) is divided into a number of sub-areas. The number of sub-areas may vary and even be adaptive, depending on, for example, the size of the extent. Typically, the number of sub-areas needed is related to how the extent is later rendered. If the rendering is based on virtual loudspeakers and the number of virtual loudspeakers is low, then there is little need to have many sub-areas since they will anyway be rendered using a virtual speaker setup with limited spatial resolution. If the extent is very small, no divisioning may be needed and then only one sub-area is defined, which will be equal to the entire modified extent.

Examples of typical sub-area divisions for different numbers of sub-areas are given below:
One sub-area: no division;
Two sub-areas: left, right;
Three sub-areas: left, center, right;
Four sub-areas: top-left, top-right, bottom-left, bottom-right;
Five sub-areas: top-left, top-right, center, bottom-left, bottom-right; and
Six sub-areas: top-left, top-center, top-right, bottom-left, bottom-center, bottom-right.

The sub-areas do not necessarily need to be the same size, but the rendering will be simplified if this is the case because the energy contribution of each sub-area is then the same.

For each sub-area, a set of rays are cast to get an estimate of how much occlusion there is for this particular part of the modified extent. For each ray cast, an occlusion filter is formed from the acoustic transmission parameters of any material that the ray passed through. The filter can be expressed as a list of gain factors for different frequency bands. For the case where the ray passes through more than one occluder, the occlusion filter is calculated by multiplying the gain of the different materials at each frequency band. If a ray is completely occluded, the occlusion filter can be set to 0.0 for all frequencies. If the ray does not pass through any occluding objects, the occlusion filter can be counted as having gain 1.0 for all frequencies. If a ray does not hit the extent of the audio object, it can be handled as a completely occluded ray or just be discarded.

For each sub-area, the occlusion filters of every ray cast are accumulated to form one occlusion filter that represents the occlusion within that sub-area. The accumulated gain per frequency band for that sub-area can then be calculated for example using:

$${G}_{SA , f} = \sqrt{\frac{{\sum }_{0}^{N} {g}_{n , f}}{N}}$$

where G_{SA,f} denotes the accumulated gain for frequency f from one sub-area, g_{n,f} is the gain for frequency f and one sample point in the sub-area and N is the number of sample points. This assumes that the audio source can be seen as a diffuse source. If the source is to be seen as a coherent source, the gains of each sample point are added together linearly according to:

$${G}_{SA , f} = \frac{{\sum }_{0}^{N} {g}_{n , f}}{N}$$

For a specific example, assume that two rays are cast towards a sub-area of the extent and the first ray passes through a thin occluding object made of a first material (e.g., cotton) and the second ray passes through a thick occluding object made of a second material (e.g., brick). That is, the point within the extent through which the first ray passes is occluded by the thin occluding object and the point within the extent through which the second ray passes is occluded by the thick occluding object. Assume also that each material is associated with a different filter (i.e., a set of frequency ranges and a gain factor for each frequency range) as illustrated in the table below:

TABLE 1

| | F1 | F2 | F3 |
|---|---|---|---|
| Material 1 | g11 | g12 | g13 |
| Material 2 | g21 | g22 | g23 |

In this example, G_{SA,F1}=sqrt((g11+g21)/2); G_{SA,F2}=sqrt((g12+g22)/2); and G_{SA,F3}=sqrt((g13+g23)/2). That is, the sub-area is associated with three different accumulated gain values (G_{SA,F1}, G_{SA,F2}, G_{SA,F3}), one for each frequency (or frequency range).

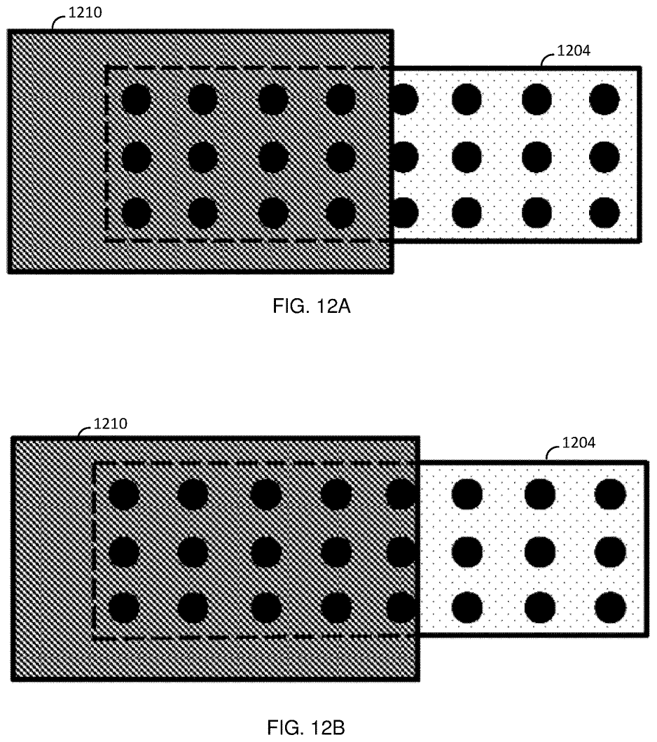

The distribution pattern of the rays over each sub-area should preferably be even. The simplest form of even distribution pattern would be a regular grid. But a regular grid pattern would mean that many sample points will be made with the same horizontal angle and many sample points with the same vertical angle. Since many occlusion situations involve occluders that have straight vertical or horizontal edges, such as wall, doorways, windows etc., this may increase the problem with stepwise behavior. This problem is illustrated in FIG. 12A and FIG. 12B.

FIG. 12A and FIG. 12B show an example of occlusion detection using 24 rays in an even grid. The extent 1204 is shown as seen from the listening position and an occluder 1210 is moving from the left to the right covering more and more of the extent. In FIG. 12A, the occluder 1210 blocks 12 of the rays (the rays are visualized as black dots). In FIG. 12B, the occluder has moved further to the right and is now blocking 15 of the rays. As the occluder moves further the amount of occlusion will change in discrete steps, which would cause audible instant changes in audio level.

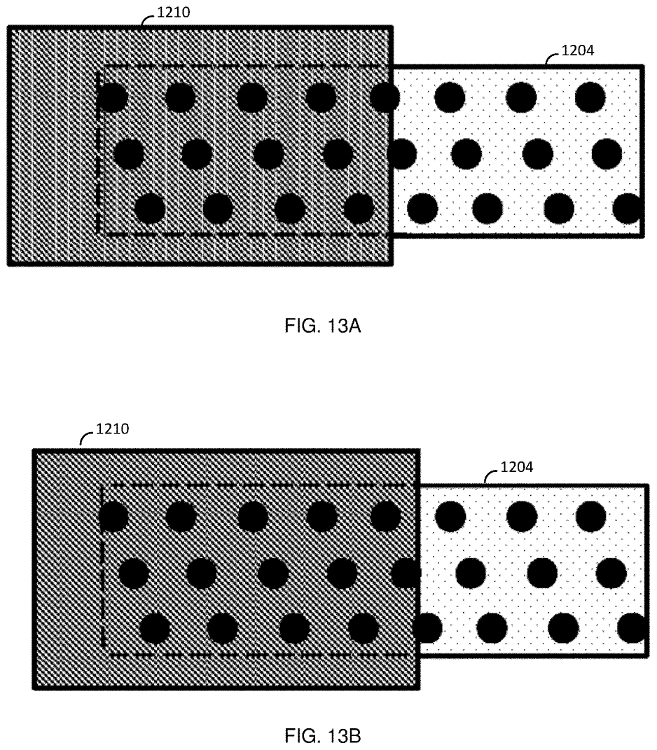

Instead of using a regular grid as shown in FIG. 12A and FIG. 12B, some form of random sampling distribution could be used, such as completely random sampling, clustered random sampling, or regular sampling with a random offset. Generally, a good distribution pattern is one where the sample points are not repeating the same vertical or horizontal angles. Such a pattern can be constructed from a regular grid where an increasing offset is added to the vertical position of samples within each horizontal row and where an increasing offset is added to the horizontal position of samples within each vertical column. Such a skewed grid pattern will distribute the sampling points so that the horizontal and vertical positions of all sampling points are as evenly distributed as possible. FIG. 13A and FIG. 13B show an example of a grid where an increasing offset is added to the horizontal positions of the sample points. As can be seen, only one extra ray is occluded when the occluder has moved. This means that the resolution of the detection has been increased by a factor of three compared to the example with a regular grid as shown in FIG. 12A and FIG. 12B using the same number of sampling points.

### 1.5 Time Varying Ray Cast Sampling Grids

The number of ray casts used for the two stages of detection can be adaptive. For example, the number of ray casts can be adapted so that the resolution is kept constant regardless of the size of the extent or the number of rays can be made dependent on the current renderer load so that fewer rays are used when there is a lot of other processing active in the renderer.

Another way to vary the number of rays is to make use of previous detection results, so that the resolution is increased for a period of time after some occlusion has been detected. This way a sparser set of rays can be used to detect if there is any occlusion at all and whenever occlusion is detected, the resolution of the next update of the occlusion state can be increased. The increased resolution can then be kept as long as there is still some occlusion detected and then for an extra period of time.

Yet another way to vary the ray cast sampling grid over time is to use a sequence of grids that complement each other so that the spatial resolution can be increased by using the accumulated results of two or more sequential grids. This would mean that the result is averaged over a longer time frame and therefore the response of the occlusion detection would be slower, similar to when applying temporal smoothing. One way to overcome this is to only use sequential grids when there has not been any previous occlusion detected for a period of time and if any occlusion is detected, switch off the sequential grid and instead use one sampling grid with high resolution. Such sequential grids may be pre-calculated or they could be generated on the fly by adding offsets to one predefined grid.

1.6 Reusing Ray-Tracing Information from Stage 1 in Stage 2

It is possible to reuse the ray tracing information from stage 1 in stage 2 if the occlusion filters for each ray cast in stage 1 is evaluated and stored so that they can be included in the calculation of the accumulated occlusion filters for each sub-area.

1.7 Reusing Occlusion Information from Previous Occlusion Detection Updates

Because scene updates are often smooth, also the change in occlusion is typically gradual. In many cases information from a previous occlusion detection can be used as a good starting point for the next update. One way to make use of previous detections is to add points from within the modified extent of the previous update when doing the first stage detection of cropping occlusion. For example, the center point of the modified extent of the previous occlusion detection update can be added as an extra sample point in the first stage. For example, combining sparse sequential grids of sample points with extra sample points from the previous modified extent can provide a very efficient way of detecting cropping occlusion.

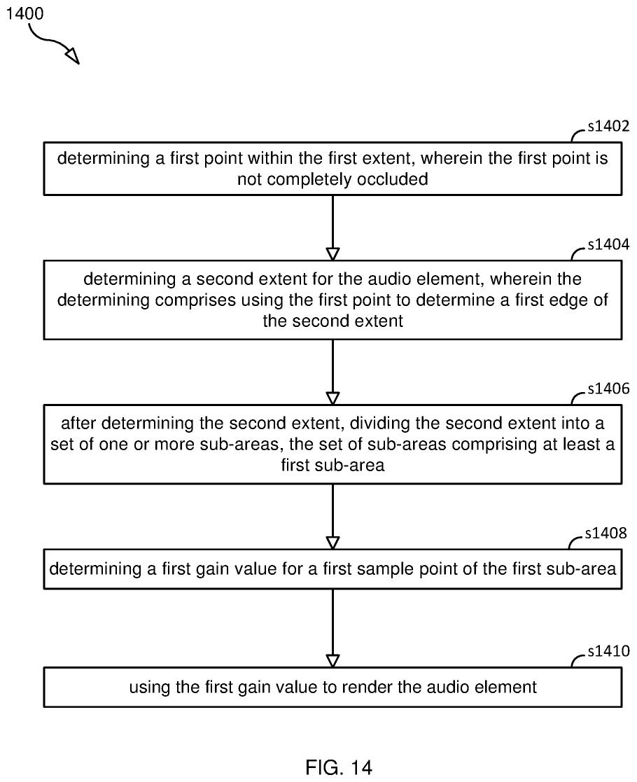

FIG. 14 is a flowchart illustrating a process 1400, according to an embodiment, for rendering an audio element associated with a first extent. The first extent may be the actual extent of the audio element as seen from the listener position or a projection of the audio element as seen from the listener position, where the projection may be for example the projection of the extent of the audio element onto a sphere around the listener or a projection of the extent of the audio element onto a plane between the audio element and the listener. International Patent Application Publication No. WO2021180820 describes a technique for projecting an audio object with a complex shape. For example the publication describes a method for representing an audio object with respect to a listening position of a listener in an extended reality scene, where the method includes: obtaining first metadata describing a first three-dimensional (3D) shape associated with the audio object and transforming the obtained first metadata to produce transformed metadata describing a two-dimensional (2D) plane or a one-dimensional (1D) line, wherein the 2D plane or the 1D line represent at least a portion of the audio object, and transforming the obtained first metadata to produce the transformed metadata comprises: determining a set of description points, wherein the set of description points comprises an anchor point; and determining the 2D plane or 1D line using the description points, wherein the 2D plane or 1D lines passes through the anchor point. The anchor point may be: i) a point on the surface of the 3D shape that is closest to the listening position of the listener in the extended reality scene, ii) a spatial average of points on or within the 3D shape, or iii) the centroid of the part of the shape that is visible to the listener; and the set of description points further comprises: a first point on the first 3D shape that represents a first edge of the first 3D shape with respect to the listening position of the listener, and a second point on the first 3D shape that represents a second edge of the first 3D shape with respect to the listening position of the listener.

Process 1400 may begin in step S1402. Step S1402 comprises determining a first point within the first extent, wherein the first point is not completely occluded. This step corresponds to a step within the first stage of the above described two stage process and the first point can correspond to point P1 in FIG. 9.

Step S1404 comprises determining a second extent (referred to above as the modified extent) for the audio element, wherein the determining comprises using the first point to determine a first edge of the second extent. This step is also a step within the first stage described above. The first edge of the second extent may be edge 950 in the case that edge 940 is completely occluded, as shown in FIG. 9, or edge 940 in the event that edge 940 is not completely occluded as shown in FIG. 11.

Step S1406 comprises, after determining the second extent, dividing the second extent into a set of one or more sub-areas, the set of sub-areas comprising at least a first sub-area.

Step S1408 comprises determining a first gain value (e.g., for a first frequency) for a first sample point of the first sub-area.

Step S1410 comprises using the first gain value to render the audio element (e.g., generate an output signal using the first gain value).

### Example Embodiments for Deriving an Occlusion Filter

A1. A method (800) for rendering an audio element (302) associated with a first extent (304), the method comprising: determining (S1402) a first point (P1) within the first extent, wherein the first point is not completely occluded; determining (S1404) a second extent (304, 1004) for the audio element, wherein the determining comprises using the first point to determine a first edge of the second extent; after determining the second extent, dividing (S1406) the second extent into a set of one or more sub-areas, the set of sub-areas comprising at least a first sub-area; determining (S1408) a first gain value for a first sample point of the first sub-area.
A2. The method of embodiment A1, wherein determining the first edge of the second extent using the first point comprises determining whether the first point is on a first edge of the first extent or within a threshold distance of the first edge of the first extent.
A3. The method of embodiment A2, wherein determining the first edge of the second extent further comprises setting the first edge of the second extent equal to the first edge of the first extent as a result of determining that the first point is on the first edge of the first extent or within the threshold distance of the first edge of the first extent.
A4. The method of embodiment A2, wherein determining the first edge of the second extent comprises: determining a third point between the first point and a second point within the first extent, wherein the second point is completely occluded; and determining whether the third point is completely occluded or not completely occluded or using the third point to define the first edge of the second extent.
A5. The method of embodiment A4, wherein determining the first edge of the second extent further comprises: determining whether the third point is completely occluded or not; and determining a fourth point between the first point and the third point if it is determined that the third point is completely occluded; or determining a fourth point between the second point and the third point if it is determined that the third point is not completely occluded.
A6. The method of embodiment A5, wherein determining the first edge of the second extent using the first point further comprises: using the fourth point to define the first edge of the second extent.
A7. The method of any one of embodiments A1-A6, wherein determining the second extent further comprises: determining a fifth point within the first extent, wherein the fifth point is not completely occluded; and using a fifth point to determine a second edge of the second extent.
A8. The method of embodiment A7, wherein determining the second edge of the second extent using the fifth point comprises determining whether the fifth point is on a second edge of the first extent or within a threshold distance of the second edge of the first extent.
A9. The method of embodiment A8, wherein determining the second edge of the second extent comprises setting the second edge of the second extent equal to the second edge of the first extent as a result of determining that the fifth point is on the second edge of the first extent or within the threshold distance of the second edge of the first extent.
A10. The method of any one of embodiments A1-A9, wherein determining the first gain value for the first sample point of the first sub-area comprises: for a virtual straight line extending from a listening position to the first sample point, determining whether or not the virtual line passes through one or more objects.
A11. The method of embodiment A10, wherein the virtual line passes through at least a first object, and the step of determining the first gain value for the first sample point of the first sub-area further comprises: obtaining first metadata associated with the first object; and determining the first gain value using the first metadata.
A12. The method of embodiment A11, wherein the virtual line further passes through a second object, and the step of determining the first gain value for the first sample point of the first sub-area further comprises: obtaining second metadata associated with the second object; and determining the first gain value using the second metadata.
A13. The method of any one of embodiments A1-A12, wherein using the first gain value to render the audio element comprises using the first gain value to calculate a first accumulated gain value for the first sub-area and using the first accumulated gain value to render the audio element.
A14. The method of embodiment A13, wherein using the first accumulated gain value to render the audio element comprises modifying an audio signal associated with the first sub-area based on the first accumulated gain value to produce a first modified audio signal and rendering the audio element using the modified audio signal.
A15. The method of any one of embodiments A1-A14, wherein determining the first gain value for the first sample point of the first sub-area comprises: casting a skewed grid of rays towards the first sub-area, wherein one of the rays intersects the sub-area at the first sample point.
A16. The method of any one of embodiments A1-A15, further comprising calculating an overall gain factor, gov, wherein using the first gain value to render the audio element comprises using the first gain value and gov to render the audio element.
A17. The method of embodiment 16, wherein the first extent has a first area, Area1, the second extent has a second area, Area2, wherein Area2<Area1, and calculating gov comprises calculating Area2/Area1.
A18. The method of embodiment 17, wherein calculating gov further comprises determining the square root of Area2/Area1.

### Example Use Case

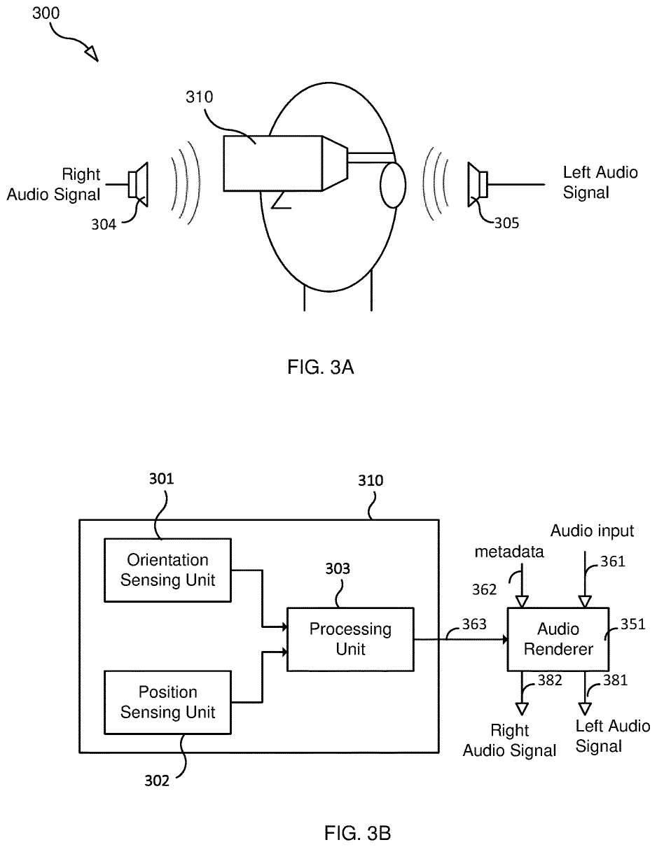

FIG. 3A illustrates an XR system 300 in which the embodiments disclosed herein may be applied. XR system 300 includes speakers 304 and 305 (which may be speakers of headphones worn by the user) and an XR device 310 that may include a display for displaying images to the user and that, in some embodiments, is configured to be worn by the listener. In the illustrated XR system 300, XR device 310 has a display and is designed to be worn on the user's head and is commonly referred to as a head-mounted display (HMD).

As shown in FIG. 3B, XR device 310 may comprise an orientation sensing unit 301, a position sensing unit 302, and a processing unit 303 coupled (directly or indirectly) to an audio render 351 for producing output audio signals (e.g., a left audio signal 381 for a left speaker and a right audio signal 382 for a right speaker as shown).

Orientation sensing unit 301 is configured to detect a change in the orientation of the listener and provides information regarding the detected change to processing unit 303. In some embodiments, processing unit 303 determines the absolute orientation (in relation to some coordinate system) given the detected change in orientation detected by orientation sensing unit 301. There could also be different systems for determination of orientation and position, e.g. a system using lighthouse trackers (LIDAR). In one embodiment, orientation sensing unit 301 may determine the absolute orientation (in relation to some coordinate system) given the detected change in orientation. In this case the processing unit 303 may simply multiplex the absolute orientation data from orientation sensing unit 301 and positional data from position sensing unit 302. In some embodiments, orientation sensing unit 301 may comprise one or more accelerometers and/or one or more gyroscopes.

Audio renderer 351 produces the audio output signals based on input audio signals 361, metadata 362 regarding the XR scene the listener is experiencing, and information 363 about the location and orientation of the listener. The metadata 362 for the XR scene may include metadata for each object and audio element included in the XR scene, as well as metadata for the XR space (“acoustic environment) in which the listener is virtually located. The metadata for an object may include information about the dimensions of the object and occlusion factors for the object (e.g., the metadata may specify a set of occlusion factors where each occlusion factor is applicable for a different frequency or frequency range). The metadata 362 may also include control parameters, such as a reverberation time value, a reverberation level value, and/or absorption parameter(s).

Audio renderer 351 may be a component of XR device 310 or it may be remote from the XR device 310 (e.g., audio renderer 351, or components thereof, may be implemented in the cloud).

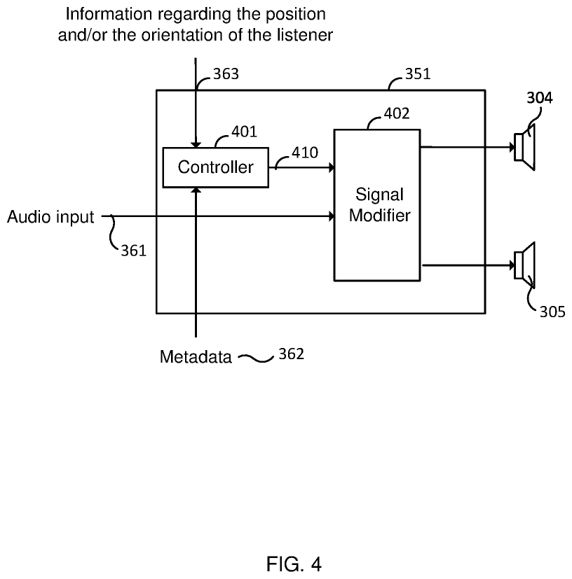

FIG. 4 shows an example implementation of audio renderer 351 for producing sound for the XR scene. Audio renderer 351 includes a controller 401 and a signal modifier 402 for generating the output audio signal(s) (e.g., the audio signals of a multi-channel audio element) based on control information 410 from controller 401 and input audio 361.

In some embodiments, controller 401 may be configured to receive one or more parameters and to trigger signal modifier 402 to perform modifications on audio signals 361 based on the received parameters (e.g., increasing or decreasing the volume level). The received parameters include information 363 regarding the position and/or orientation of the listener (e.g., direction and distance to an audio element), and metadata 362 regarding the XR scene. As noted above, metadata 362 may include metadata regarding the XR space in which the user is virtually located (e.g., dimensions of the space, information about objects in the space and information about acoustical properties of the space) as well as metadata regarding audio elements and metadata regarding an object occluding an audio element. In some embodiments, controller 401 itself produces at least a portion of the metadata 362. For instance, controller 401 may receive metadata about the XR scene and derive additional metadata (e.g., control parameters) based on the received metadata. For instance, using the metadata 362 and position/orientation information 363, controller 401 may calculate one or more gain values (g) for an audio element in the XR scene.

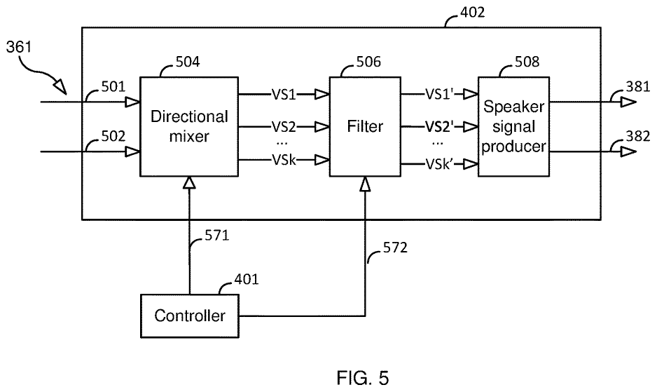

FIG. 5 shows an example implementation of signal modifier 402 according to one embodiment. Signal modifier 402 includes a directional mixer 504, a filter 506, and a speaker signal producer 508.

Directional mixer 504 receives audio input 361, which in this example includes a pair of audio signals 501 and 502 associated with an audio element (e.g. audio element 602), and produces a set of k virtual loudspeaker signals (VS1, VS2, . . . , VSk) based on the audio input and control information 571. In one embodiment, the signal for each virtual loudspeaker can be derived by, for example, the appropriate mixing of the signals that comprise the audio input 361. For example: VS1=α×L+β×R, where L is input audio signal 501, R is input audio signal 502, and a and B are factors that are dependent on, for example, the position of the listener relative to the audio element and the position of the virtual loudspeaker to which VS1 corresponds.

In the example where an audio source being rendered is associated with three virtual loudspeakers (TL, M, and TR), then k will equal 3 for the audio element and VS1 may correspond to TL, VS2 may correspond to M, and VS3 may correspond to TR. The control information 571 used by directional mixer to produce the virtual loudspeaker signals may include the positions of each virtual loudspeaker relative to the audio element. In some embodiments, controller 401 is configured such that, when the audio element is occluded, controller 401 may adjust the position of one or more of the virtual loudspeakers associated with the audio element and provide the position information to directional mixer 504 which then uses the updated position information to produce the signals for the virtual loudspeakers (i.e., VS1, VS2, . . . , VSk).

Filter 506 may filter (e.g., adjust the gain of) any one or more of the virtual loudspeaker signals based on control information 572, which may include the above described mapped filters as calculated by controller 401. That is, for example, when the audio element is at least partially occluded, controller 401 may control filter 506 to filter (adjust the gain of) one or more of the virtual loudspeaker signals by providing corresponding one or more mapped filters to filter 506. For instance, if the entire left portion of the audio element is occluded, then controller 401 may provide to filter 506 control information 572 that causes filter 506 to reduce the gain of VS1 by 100% (i.e., gain value=0 so that VS1′=0). As another example, if only 50% of the left portion of the audio element is occluded and 0% of the center portion is occluded, then controller 401 may provide to filter 506 control information 572 that causes filter 506 to reduce the gain of VS1 by 50% (i.e., VS1′=50% VS1) and to not reduce the gain of VS2 at all (i.e., gain value=1 so that VS2′=VS2).

Using virtual loudspeaker signals VS1′, VS2′, . . . , VSk′, speaker signal producer 508 produces output signals (e.g., output signal 381 and output signal 382) for driving speakers (e.g., headphone speakers or other speakers). In one embodiment where the speakers are headphone speakers, speaker signal producer 508 may perform conventional binaural rendering to produce the output signals. In embodiments where the speakers are not headphone speakers, speaker signal producer 508 may perform conventional speaking panning to produce the output signals.

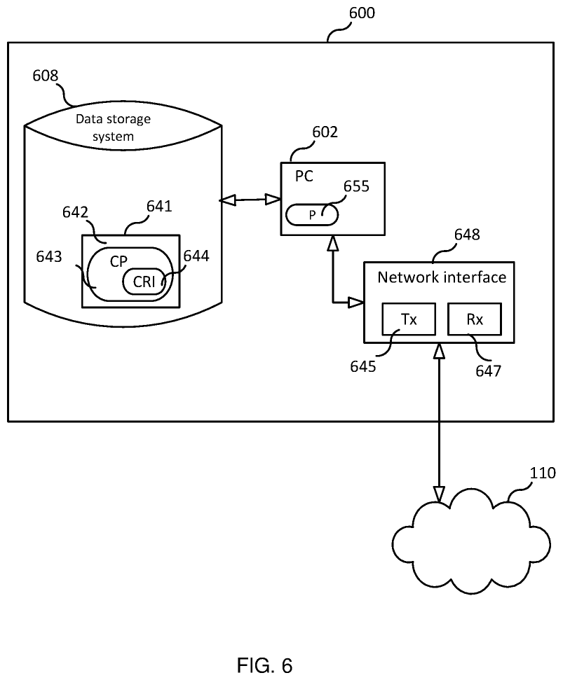

FIG. 6 is a block diagram of an audio rendering apparatus 600, according to some embodiments, for performing the methods disclosed herein (e.g., audio renderer 351 may be implemented using audio rendering apparatus 600). As shown in FIG. 6, audio rendering apparatus 600 may comprise: processing circuitry (PC) 602, which may include one or more processors (P) 655 (e.g., a general purpose microprocessor and/or one or more other processors, such as an application specific integrated circuit (ASIC), field-programmable gate arrays (FPGAs), and the like), which processors may be co-located in a single housing or in a single data center or may be geographically distributed (i.e., apparatus 600 may be a distributed computing apparatus); at least one network interface 648 comprising a transmitter (Tx) 645 and a receiver (Rx) 647 for enabling apparatus 600 to transmit data to and receive data from other nodes connected to a network 110 (e.g., an Internet Protocol (IP) network) to which network interface 648 is connected (directly or indirectly) (e.g., network interface 648 may be wirelessly connected to the network 110, in which case network interface 648 is connected to an antenna arrangement); and a storage unit (a.k.a., “data storage system”) 608, which may include one or more non-volatile storage devices and/or one or more volatile storage devices. In embodiments where PC 602 includes a programmable processor, a computer program product (CPP) 641 may be provided. CPP 641 includes a computer readable medium (CRM) 642 storing a computer program (CP) 643 comprising computer readable instructions (CRI) 644. CRM 642 may be a non-transitory computer readable medium, such as, magnetic media (e.g., a hard disk), optical media, memory devices (e.g., random access memory, flash memory), and the like. In some embodiments, the CRI 644 of computer program 643 is configured such that when executed by PC 602, the CRI causes audio rendering apparatus 600 to perform steps described herein (e.g., steps described herein with reference to the flow charts). In other embodiments, audio rendering apparatus 600 may be configured to perform steps described herein without the need for code. That is, for example, PC 602 may consist merely of one or more ASICs. Hence, the features of the embodiments described herein may be implemented in hardware and/or software.

### Summary of Various Embodiments

A1. A method for rendering an at least partially occluded audio element (100), the method comprising: obtaining a matrix of occlusion filters, Fo; obtaining at least a first mapping matrix, M1; using Fo and M1 to generate a matrix of mapped filters, Fs, wherein Fs includes at least a first mapped filter, Fm1, corresponding to a first virtual loudspeaker; using Fm1 to modify a first virtual loudspeaker signal (e.g., VS1, VS2, or . . . ) for the first virtual loudspeaker, thereby producing a first modified virtual loudspeaker signal; and using the first modified virtual loudspeaker signal to render the audio element (e.g., generate an output signal using the first modified virtual loudspeaker signal).
A2. The method of embodiment A1, wherein the audio element comprises N subareas; and Fo includes N occlusion filters, each one of the N occlusion filters corresponding to a different one of the N subareas.
A3. The method of embodiment A1 or A2, wherein M1 is associated with a first virtual loudspeaker configuration, the first virtual loudspeaker configuration having at total of M virtual loudspeakers, and M1 is a N×M matrix of scaling factors.
A4. The method of any one of embodiments A1-A3, further comprising obtaining a second mapping matrix, M2, wherein M2 is associated with a second virtual loudspeaker configuration, and Fo, M1, and M2 are used to generate the matrix of mapped filters, Fs.
A5. The method of embodiment A4, wherein: Fs=((a)(M1)+(1−a)(M2))×Fo, were a is a control parameter.
A6. The method of embodiment A5, further comprising: determining an angular width, w, of the audio element, and calculating a using w.
A7. The method of embodiment A4, further comprising obtaining a third mapping matrix, M3, wherein Fo, M1, M2, and M3 are used to generate the matrix of mapped filters, Fs.
A8. The method of embodiment A7, wherein Fs=((aₚₒᵢₙₜ)(M1)+(aₗᵢₙₑ)(M2)+(aₚₗₐₙₑ)(m3))×Fo, were aₚₒᵢₙₜ, aₗᵢₙₑ, and aₚₗₐₙₑ are control parameters.
A9. The method of embodiment A8, further comprising: determining an angular width, w, of the audio element; determining an angular height, h, of the audio element; calculating aₚₒᵢₙₜ using w; calculating aₗᵢₙₑ using w and h; and calculating aₚₗₐₙₑ using w and h;
A10. The method of embodiment A9, wherein calculating aₚₒᵢₙₜ using w comprises calculating: 1−HT(w), where HT(w)=(sin(w)−sin(π/32))/(sin(π/12)−sin (π/32)).
A11. The method of embodiment A10, wherein calculating aₗᵢₙₑ using w and h comprises calculating: (HT(w))(1−VT(h)), where VT(h)=(sin(h)−sin(π/32))/(sin(π/12)−sin(π/32)).
A12. The method of embodiment A11, wherein calculating aₚₗₐₙₑ using w and h comprises calculating: (HT(w))(VT(h)).
A13. The method of any one of embodiments A1-A12, wherein Fm1 is a normalized filter.
A14. The method of any one of embodiments A1-A3, wherein the audio element is associated with a first extent, and obtaining the matrix of occlusion filters comprises: determining a first point (P1) within the first extent, wherein the first point is not completely occluded; determining a second extent for the audio element, wherein the determining comprises using the first point to determine a first edge of the second extent; after determining the second extent, dividing the second extent into a set of one or more sub-areas, the set of sub-areas comprising at least a first sub-area; and determining (S1408) a first gain value for a first sample point of the first sub-area.
A15. The method of embodiment A14, wherein using the first point (P1) to determine a first edge of the second extent comprise performing a binary search between the first point (P1) and a second point (P2) within the first extent that is occluded.
B1. A computer program comprising instructions which when executed by processing circuitry of an audio renderer causes the audio renderer to perform the method of any one of the above embodiments.
B2. A carrier containing the computer program wherein the carrier is one of an electronic signal, an optical signal, a radio signal, and a computer readable storage medium.
C1. An audio rendering apparatus that is configured to perform the method of any one of the above embodiments.
C2. The audio rendering apparatus of embodiment C1, wherein the audio rendering apparatus comprises memory and processing circuitry coupled to the memory.

While various embodiments are described herein, it should be understood that they have been presented by way of example only, and not limitation. Thus, the breadth and scope of this disclosure should not be limited by any of the above described exemplary embodiments. Moreover, any combination of the above-described objects in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### REFERENCES

[1] MPEG-H 3D Audio, Clause 8.4.4.7: “Spreading”
[2] MPEG-H 3D Audio, Clause 18.1: “Element Metadata Preprocessing”
[3] MPEG-H 3D Audio, Clause 18.11: “Diffuseness Rendering”
[4] EBU ADM Renderer Tech 3388, Clause 7.3.6: “Divergence”
[5] EBU ADM Renderer Tech 3388, Clause 7.4: “Decorrelation Filters”
[6] EBU ADM Renderer Tech 3388, Clause 7.3.7: “Extent Panner”
[7] Efficient HRTF-based Spatial Audio for Area and Volumetric Sources”, IEEE Transactions on Visualization and Computer Graphics 22(4):1-1⋅January 2016
[8] Patent Publication WO2020144062, “Efficient spatially-heterogeneous audio elements for Virtual Reality.”

1. A method for rendering an at least partially occluded audio element, the method comprising:
obtaining a matrix of occlusion filters, Fo;
obtaining at least a first mapping matrix, M1;
using Fo and M1 to generate a matrix of mapped filters, Fs, wherein Fs includes at least a first mapped filter, Fm1, corresponding to a first virtual loudspeaker;
using Fm1 to modify a first virtual loudspeaker signal for the first virtual loudspeaker, thereby producing a first modified virtual loudspeaker signal; and
using the first modified virtual loudspeaker signal to render the audio element.

2. The method of claim 1, wherein
the audio element comprises N subareas; and
Fo includes N occlusion filters, each one of the N occlusion filters corresponding to a different one of the N subareas.

3. The method of claim 1, wherein
M1 is associated with a first virtual loudspeaker configuration, the first virtual loudspeaker configuration having at total of M virtual loudspeakers, and
M1 is a N×M matrix of scaling factors.

4. The method of claim 1, wherein the method further comprises obtaining a second mapping matrix, M2, wherein
M2 is associated with a second virtual loudspeaker configuration, and
Fo, M1, and M2 are used to generate the matrix of mapped filters, Fs.

5. The method of claim 4, wherein:
Fs=((a)(M1)+(1−a)(M2))×Fo, were a is a control parameter.

6. The method of claim 5, wherein the method further comprises:
determining an angular width, w, of the audio element, and
calculating a using w.

7. The method of claim 4, wherein the method further comprises obtaining a third mapping matrix, M3, wherein Fo, M1, M2, and M3 are used to generate the matrix of mapped filters, Fs.

8. The method of claim 7, wherein
Fs=((aₚₒᵢₙₜ)(M1)+(aₗᵢₙₑ)(M2)+(aₚₗₐₙₑ)(m3))×Fo, were aₚₒᵢₙₜ, aₗᵢₙₑ, and aₚₗₐₙₑ are control parameters.

9. The method of claim 8, wherein the method further comprises:
determining an angular width, w, of the audio element;
determining an angular height, h, of the audio element;
calculating aₚₒᵢₙₜ using w;
calculating aₗᵢₙₑ using w and h; and
calculating aₚₗₐₙₑ using w and h.

10. The method of claim 9, wherein calculating aₚₒᵢₙₜ using w comprises calculating: 1−HT(w), where HT(w)=(sin(w)−sin(π/32))/(sin(π/12)−sin(π/32)).

11. The method of claim 10, wherein calculating aₗᵢₙₑ using w and h comprises calculating: (HT(w))(1−VT(h)), where VT(h)=(sin(h)−sin(π/32))/(sin(π/12)−sin(π/32)).

12. The method of claim 11, wherein calculating aₚₗₐₙₑ using w and h comprises calculating: (HT(w))(VT(h)).

13. The method of claim 1, wherein Fm1 is a normalized filter.

14. The method of claim 1, wherein
the audio element is associated with a first extent, and
obtaining the matrix of occlusion filters comprises:
determining a first point (P1) within the first extent, wherein the first point is not completely occluded;
determining a second extent for the audio element, wherein the determining comprises using the first point to determine a first edge of the second extent;
after determining the second extent, dividing the second extent into a set of one or more sub-areas, the set of sub-areas comprising at least a first sub-area; and
determining a first gain value for a first sample point of the first sub-area.

15. The method of claim 14, wherein using the first point to determine a first edge of the second extent comprises performing a binary search between the first point and a second point within the first extent that is occluded.

16-17. (canceled)

18. An audio rendering apparatus, wherein the audio rendering apparatus is configured to perform a method for rendering an at least partially occluded audio element, wherein the method comprises:
obtaining a matrix of occlusion filters, Fo;
obtaining at least a first mapping matrix, M1;
using Fo and M1 to generate a matrix of mapped filters, Fs, wherein Fs includes at least a first mapped filter, Fm1, corresponding to a first virtual loudspeaker;
using Fm1 to modify a first virtual loudspeaker signal for the first virtual loudspeaker, thereby producing a first modified virtual loudspeaker signal; and
using the first modified virtual loudspeaker signal to render the audio element.

19. The audio rendering apparatus of claim 18, wherein
the audio element comprises N subareas; and
Fo includes N occlusion filters, each one of the N occlusion filters corresponding to a different one of the N subareas.

20. The audio rendering apparatus of claim 18, wherein
M1 is associated with a first virtual loudspeaker configuration, the first virtual loudspeaker configuration having at total of M virtual loudspeakers, and
M1 is a N×M matrix of scaling factors.

21. The audio rendering apparatus of claim 18, wherein the method further comprises obtaining a second mapping matrix, M2, wherein
M2 is associated with a second virtual loudspeaker configuration, and
Fo, M1, and M2 are used to generate the matrix of mapped filters, Fs.

22. The audio rendering apparatus of claim 21, wherein:
Fs=((a)(M1)+(1−a)(M2))×Fo, were a is a control parameter.

23. The audio rendering apparatus of claim 22, wherein the method further comprises:
determining an angular width, w, of the audio element, and
calculating a using w.

24. The audio rendering apparatus of claim 21, wherein the method further comprises obtaining a third mapping matrix, M3, wherein Fo, M1, M2, and M3 are used to generate the matrix of mapped filters, Fs.

25. The audio rendering apparatus of claim 24, wherein
Fs=((aₚₒᵢₙₜ)(M1)+(aₗᵢₙₑ)(M2)+(aₚₗₐₙₑ)(m3))×Fo, were aₚₒᵢₙₜ, aₗᵢₙₑ, and aₚₗₐₙₑ are control parameters.

26. The audio rendering apparatus of claim 25, wherein the method further comprises:
determining an angular width, w, of the audio element;
determining an angular height, h, of the audio element;
calculating aₚₒᵢₙₜ using w;
calculating aₗᵢₙₑ using w and h; and
calculating aₚₗₐₙₑ using w and h.

27-32. (canceled)
